(19) United States
(12) Patent Application Publication
(10) Pub. No.: US 2007/0022385 A1
(43) Pub. Date: Jan. 25, 2007

(54) Software module, method and system for managing information items by bookmarking information items through activation of said items

(76) Inventor: Mikhail Denissov, Mississauga (CA)

Correspondence Address: Stephen B. Salai, Esq.;Harter, Secrest & Emery LLP, 1600 Bausch & Lomb Place, Rochester, NY, 14604-2711, US

(21) Appl. No.: 11/185,487

(22) Filed: Jul. 20, 2005

(51) Int. Cl. G06F 9/00

(52) U.S. Cl. 715/745

(57) ABSTRACT

A software module, method and system for managing and retrieving information items through activation, especially by bookmarking information items, are disclosed. User's attention strengths and activation of information items are monitored and measured. Information items are ranked and prioritized accordingly to its activation for ease in retrieval of information items. A bookmark feature for bookmarking information items is provided for elevating relevance or importance of the information items by boosting activation of the information items. Conceptual or virtual container is also provided to the users for categorizing or grouping bookmarks. Combining aforementioned inventive features with a local search engine provides a human brain-like information management and retrieval system.

### RELATED APPLICATIONS

This application is related to co-pending U.S. patent applications Ser. No. 11/021,125, filed Dec. 22, 2004, and Ser. No. 11/131,998, filed May 18, 2005.

### FIELD OF THE INVENTION

The present invention relates generally to information retrieval in a personal computerized system or a computer network. More specifically, it relates to a software module, method and system for bookmarking information items through activation toward the items.

### BACKGROUND OF THE INVENTION

The design and implementation of bookmarking an information item for ease of later access within a computer system or computer network, similar to that of putting bookmarks at pages within a book, has been under rigorous study ever since the World Wide Web delivered massive information through our browser window. The reasons behind bookmarking an information item can either be a temporarily one, for ease of one or few subsequent accesses to finish consuming the information item (much like reading a book), or a permanent one, to reflect the usefulness or relevance of the information item by establishing a means of quick access.

Existing web browsers create bookmarks through establishing a link to the URL (Uniform Resource Locator) of the information item, since this is the fastest means of retrieving the information item. However, it is common that bookmarks could grow rapidly to the hundreds over only a few weeks of web browsing. One common feature or solution of all the browsers nowadays is to provide a way to categorize bookmarks. However, the users are left with the tasks to manage these bookmarks, to remember what he or she has bookmarked, as well as to sift through these bookmarks when recalling is desired.

U.S. Pat. No. 6,212,522, “Searching and Conditionally Serving Bookmark Sets Based on Keywords,” issued on Apr. 3, 2001 to Himmel et al. discloses a method to resolve management of bookmarks through searchable keywords specified by users or keywords related to a topic within a bookmark set, however, this still requires users to manage the bookmark sets manually through association of keywords. Another problem of existing information bookmark technology is the absence of ranking for the bookmarks. Since all bookmarks only contain the access mechanism, there is no representation of the importance or usefulness of one over the other when choosing bookmarks under the same topics.

U.S. Pat. No. 6,480,852, “Method and System for Rating Bookmarks in a Web Browser,” issued on Nov. 12, 2002 to Himmel et al. has addressed this problem through providing specific user interface for rating bookmarks, or server hosting shared bookmark relevance. However, this still incurs the burden of managing the bookmarks on the user, also, there is no mechanism to automatically “forget” bookmarks not being used.

It would be desirable to provide a software module, method and system, by which bookmark entries could be self-managed, carried ranking properties, worked seamlessly with a search system (or engine), and worked across heterogeneous types of information items such as e-mails, web pages and documents etc.

### SUMMARY OF THE INVENTION

The present invention relates generally to information management in a personal computerized system or a computer network. More specifically, it relates to a software module, method and system by bookmarking information items through activation toward the information items.

According to the first aspect of the invention, it provides an information management software module for managing information items by bookmarking through activation of the information items executing on a personal computerized system, the software module comprises instructions: to receive a first input from a user for specifying any of the information items for bookmarking; to adjust the activation of said any of the information items aforementioned; and to store the adjusted activation of said any of the information items aforementioned in a storage means; wherein the activation of the information items is continuously updated simultaneously as the user consume the information items by the software module, and the software module comprise instructions: to monitor and measure attention strengths of the user on each of the information items presented on a presentation channel; to measure activation of the information items over time; and to store the activation of the information item in the storage means; wherein the software module ranks searched information items, and the software module further comprises instructions: to receive a second input from the user for search criteria; and to retrieve and to rank one or more information items, which match the search criteria, according to the activation of the information items.

According to the second aspect of the invention, it provides a method for managing information items by bookmarking information items on a personal computerized system through activation toward the information items, the method of managing information items comprises steps of: receiving a first input from a user for specifying any of the information items for bookmarking; adjusting the activation of said any of the information items aforementioned; and storing the adjusted activation of said any of the information items aforementioned in a storage means; wherein the method comprises a plurality of steps for updating the activation of the information items continuously and simultaneously as the user consume the information items, and the plurality of steps for updating the activation of the information items comprise steps of: monitoring and measuring attention strengths of the user on each of the information items presented on a presentation channel; measuring activation of the information items over time; and storing the activation of the information item in the storage means; wherein the method further comprises a plurality of steps for ranking searched information items, and the plurality of steps for ranking searched information items comprises steps of: receive a second input from the user for search criteria; and to retrieve and to rank one or more information items, which match the search criteria, according to the activation of the information items.

According to the third aspect of the invention, it provides a system for managing information items by bookmarking the information items through activation of the information items on a personal computerized system comprises: (i) a first input means for receiving input from a user for bookmarking the information item; and (ii) a processing means for adjusting the activation of the information items that the user bookmarked; wherein the system further comprises means for updating the activation of the information items continuously and simultaneously as the user consumes and for retrieving and ranking the information items, comprising: (iii) a second input means for sensing user attention strengths of the information items; (iv) the processing means for measuring attention strengths of the information items, and for measuring activation of information items over time; (v) a storage means for storing activation information of the information items; and (vi) the processing means for searching and retrieving from the information items based on search criteria, and for ranking retrieved information items based on the activation of the information items.

### BRIEF DESCRIPTION OF THE DRAWINGS

The invention will now be described in more detail with reference to the accompanying drawings, in which:

FIG. 1 illustrates a system process flow within a preferred embodiment of the present invention;

FIG. 2 illustrates a flow chart of bookmarking process in the preferred embodiment of the present invention;

FIG. 3 illustrates a system view of how bookmarking takes place in the preferred embodiment of the present invention;

FIG. 4 illustrates a flow chart for generating container in the preferred embodiment of the present invention;

FIG. 5 illustrates an example of a container containing a number of information items in the preferred embodiment of the present invention;

FIG. 6 illustrates an example of how the container limits the number of bookmarked information items in the preferred embodiment of the present invention;

FIG. 7 illustrates an example of how the system limits the number of containers in the preferred embodiment of the present invention;

FIG. 8 illustrates an example of how the system ranks information items based on the activation scores in the preferred embodiment of the present invention; and

FIG. 9 illustrates an example of how the system ranks information items associated with a container based on search query in the preferred embodiment of the present invention.

### DETAILED DESCRIPTION OF THE INVENTION

The present invention is illustrated within a preferred embodiment to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments illustrated but is to be accorded the widest scope consistent with the principles and features described herein.

Personal computerized systems have become an integral part of workplace tools and personal information management systems at homes. The information items consumed within these systems reflect the interests of the users, and are essentially becoming an extended memory of the users. As availability of various kinds of information increased drastically with the advance of Internet/pervasive computer technology, the amount of information that each of the users consumes everyday has accordingly become enormously large. The number of information management tools for managing such vast amount of information that the user needs to learn and use has grown as well. Managing and retrieving such information with an integrated tool have become increasingly critical for many people.

Therefore, the objectives of the present invention is to provide a software module, method, and system for managing and retrieving heterogeneous information items in a personal computerized system through activation towards the information items by (a) monitoring and measuring user attention strengths and activation towards the information items to determine importance/usefulness/relevance, (b) ranking information items based on importance, usefulness and/or relevance automatically and dynamically, (c) categorizing/grouping information items independent of physical locations, and (d) working seamlessly with a search system.

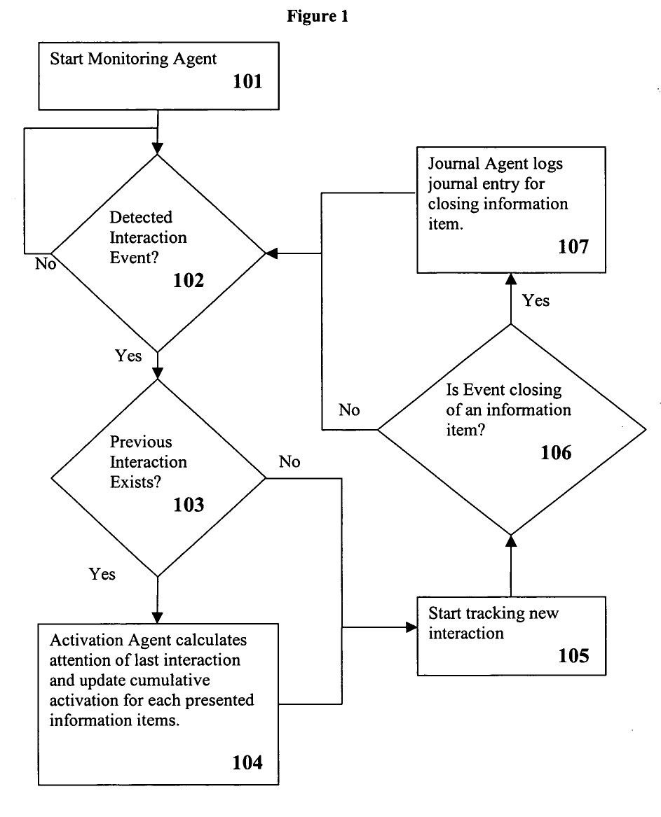

FIG. 1 illustrates monitoring and tracking interaction events in the present invention within a preferred embodiment. The events signifying start of an interaction includes, without limitation, openings/closing/focusing/de-focusing/input of information items by a specific user. The monitoring agent 101 continuously monitors all aforementioned interaction events 102 among concurrently presented information items. The monitoring agent 101 can be a user attention tracking device or a computer executable program executed on a processing means (such as a CPU on a personal computer) that monitors its inputs (i.e. keyboard, mouse, etc) and outputs (display, speakers, etc) to track the user's attention. In the preferred embodiment of this invention, the monitoring agent 101 is the computer executable program residing in a processing means. The information items include, but not limited to, e-mails, web pages, and user application files such as Microsoft Word, Excel, Access, and PowerPoint files. Other examples of information items are multimedia files, such as MP3, MPEG4, JPEG, etc. Once detecting an event of interaction, the monitoring agent checks whether previous interaction exists 103. If previous interaction exists the monitoring agent measures the duration of the interaction period as time difference between detected events, and divides the duration of the interaction period into attention units appropriate to the corresponding presentation channel. It basically counts the number of attention units within the interaction period during which the user directed attention towards the information items proactively and counts the number of attention units within the interaction period during which the user directed attention towards the information items passively. Then, it allocates the attention units of the proactive interaction to the target information items and the attention units of the passive interaction among the target information items and all of the rest of the presented information items in the presentation channel, based on the presentation characteristics of each of the information items in the presentation channel. The calculated attention strength is then passed to the activation agent 104 for recording of attention and updating activation for each of the information items in a storage means. The storage means can be a locally or remotely mounted large capacity memory device, database or any structural storage means. In the course of no previous interaction exists, or after previous interaction has been processed in aforementioned steps, the monitoring agent starts tracking of the new interaction 105. If the detected event is closing of an information item 106, then journal agent is informed and will log journal entry for the information item 107. Note that the event signifies the end of an interaction period does not necessarily have to be an information-consumption terminating event such as closing a document.

The attentions of a user towards presented information items are serialized events across time. In other words, when two documents are concurrently presented, the user can only focus on one specific document at a specific time. Therefore the measurement of attention is achieved by monitoring the occurrences of events that provide an indication of attention (or absence of attention) and the time lag between such events. Examples of such attention-related events include, without limitation, detectable events such as the change in size of information items, rates of change of information items, user inputs via input devices, activation of screen savers, etc. The lag times are small time gaps between events that can be regarded as part of the continuum of the occurred events, such as the lag time between keystrokes in a keyboard input process. When the time between events is greater than a pre-selected lag threshold, a time gap between events is said to have occurred. The occurrence of such attention-related events can be modeled, for either typical humans or specific users, using a probability density function, with the function chosen depending on the characteristics of presentation within a particular presentation channel, as well as the methods of user interactions with the presentation channel.

Presentation channel includes any channel by which an information item can be presented for consumption by a user, and includes, but not limited to, any visual, audio and/or any other sensing channel. For example, in a preferred embodiment employing a visual presentation channel, the attention-related events are considered to have equal weights, and so a probability density function with a lognormal distribution would be chosen. However, in a system featuring events that differ from each other in the degree to which they can draw attention, the events are not equally weighted and two or more lognormal distributions, or other probability density functions may be employed. In either case, when the probability density of events drops below a certain threshold, it can be assumed that user is no longer paying attention. The aforementioned attention measurement plays an important role in measuring the activation of an information item.

The following formula is used to measure activation of an information item in the ACT-R model to information retrieval:

$${A}_{i} = {B}_{i} + {\sum }_{j} {W}_{j} * {S}_{ij} + {\sum }_{k} {MP}_{k} * {Sim}_{kl} + N ( 0 , s ) \qquad [ I ]$$

where,
Aᵢ represents the activation of an information item i,
Bᵢ represents the base activation of the information item i,

$${\sum }_{j} {W}_{j} * {S}_{ij}$$
represents the associative activation between information items, where Wⱼ is a weighting factor and Sᵢⱼ is the strength of association between the information item i and source j or associative strength of the information item i,

$${\sum }_{k} {MP}_{k} * {Sim}_{kl}$$
represents the partial matching of information items towards a goal, and
N(0,s) represents a noise factor.

Note that associative strength of the information item i (Sᵢⱼ) can be measured based on the following formula:

$${S}_{ij} = ln \frac{P ( i \text{\vert} j )}{P ( \overline{i} \text{\vert} j )} \qquad [ I \text{-} a ]$$

where P(i|j) is the probability of an information item i being presented when source information item j is present, and P( i̅|j) is the probability of any information item other than i being present when the source information item j is present.

The most important measurement is base activation which, for the purpose of the invention, represents the general past usefulness of an information item, and is one of the main areas of focus of the present invention. The associative activation represents similarity in the concepts associated with information items, and is also a significant area of the focus of the invention. Furthermore, the present invention also measures the partial matching of user query to information items, or partial matching of context represented by information items by analyzing co-occurrence statistics of information items within an information space.

In a preferred embodiment of the present invention, the base activation of presented information items is measured and updated whenever new attention-related events occur; where “base activation” or “base level activation” means activation determined solely by the frequency, duration and recentness of use of an information item, thereby quantifying the general past usefulness of the information item and providing a general context-independent estimation of how likely the information item is to be useful, and “base activation of an interaction” means an instance of practice of an information item, and includes, without limitation, both base activation arising from the presentation of the information item and/or from actual user interaction with the information item. The time elapsed since the previous event occurred contains a number of evenly spaced time slots, hereinafter called attention units. In a visual presentation channel without external attention-tracking devices, the attention unit is the eye-fixation time in biological band, ranging from 200-400 milliseconds, which models the amount of time that it takes a human to fix an eye on an information item depending on the complexity of the presented item and the characteristics of the user. The determination of the amount of attention units can be further calibrated through software applications. When eye-tracking devices are available, the eye fixation and saccades statistics will provide more precise measurement of attention units. The number of attention units received by an information item within the period of consumption represents its strength of activation during the consumption.

When the base activation of the presented information items is updated, the attention units are distributed to the presented information items according to their occupancy percentage of space within the presentation channel(s). However, this distribution does not always correspond to the perceived occupancy of the items within the presentation channel. For example, if an item has the full attention of a user (which can be assumed from some form of user interaction with the item such as keyboard entries), the information item will logically occupy 100% of the presentation space as far as the user is concerned and so the number of attention units allocated to the item will reflect that. In the scenario when no user activities are detected, the presentation characteristics of the items will depend on their characteristics within the presentation channel. In a visual channel, such characteristics could include for example, relative size and color contrast, animation, and distance of items from the previous item that enjoyed full user attention, to name a few, and such characteristics will all contribute to the number of attention units allocated to each item. Finally, as stated above, when the absence of attention-related activities is detected based on pre-defined thresholds, the absence of attention is assumed. The pre-defined thresholds can be generated through monitoring user behavior, or through user-configured value, or a value based upon general attention span.

It should be noted that the same principles could be applied to other presentation channels. For example, in an audio channel, attention units could be represented by the smallest note length perceptible by humans, i.e., approximately 1/128 second, or one or more multiples of the note length whenever applicable, whereas presentation characteristics can be related to audio signal volumes, frequencies, loudness (perceived volume), pitch (perceived frequency) and other psychoacoustic parameters of such signals.

The decay in human memory can be modeled mathematically by decreasing negatively accelerating functions such as power and exponential functions. The present invention employs the power function originated in the power law of forgetting and deployed in ACT-R, a theory and related cognitive architecture for simulating and understanding human cognition, with a focus on how human knowledge is acquired and deployed, adapted to the information management context of the present invention to measure the base activation of an information item i over time in an information context. That formula is:

$${B}_{i} = ln {\sum }_{j = 1}^{n} {S}_{ij} {t}_{j}^{- d} \qquad [ II ]$$

where,

Bᵢ is the attention or base activation of an information item i gained through presentation or user activities,

Sᵢⱼ is the strength information item i at its j^{th} occurrence based on presentation characteristics or user activities,

tⱼ is the time lapsed since the j^{th} occurrence of information item i,

d is the decay parameter that simulates the process of “forgetting” in the context of information items, and

n is the number of times the information i has occurred.

Note that the strength Sᵢⱼ varies at each instant in time according to presentation characteristics or types of user activities, and is represented by the number of aforementioned attention units allocated to each information item. It should also be noted that the formula [II] captures the cumulative nature of base activation, meaning that the measurement of base activation at any instant in time according to the formula will take into account the residual activation and decay associated with previous interactions, whether those previous interactions result from user interactions with the information item or from presentation of the information item.

When attention tracking and attention/decay emulation devices are present, the cumulative attention (i.e., attention units) directed towards an information item can be precisely measured since the attention strength and decay associated with individual attention units can be accurately tracked and allocated to information items. However, in a preferred embodiment without the aforementioned devices, the attention of each interaction period is measured as groups of attention units being distributed among presented items. The interaction period begins with a noticeable event signifying the beginning of attention (such as opening an item or resuming attention), to another noticeable events signifying the end of attention (such as closing an item or absence of attention detected).

The present invention distributes attention units to concurrently presented information items based on the detection of user activities and presentation characteristics of the information items. For example, if any targeted user activities towards an information item such as inputs are detected, the information item is said to have the undivided attention of user and the strength (S) is equal to sum of all attention units within the period of interaction. In other words, the rest of the concurrently presented information items will receive zero attention during the user's proactive interaction with the information item and hence will not receive any allocation of attention units. In the absence of user activities (or during the user's passive interaction with information items), attention units will be allocated to presented information items using probability-based statistical techniques for predicting user eye-fixation, or other such perceptual cues as measures of attention. In a preferred embodiment, the present invention assumes that user attention to each presented information item is proportional to the space occupied by the item within the presentation channel, hereinafter referred as occupancy percentage. However, as aforementioned, the occupancy percentage does not relate only to physical dimensions, but also depends on the presentation characteristics of the information item, including without limitation, any event such as rate of change of presentation, presence or addition of sound, static and dynamic graphical elements, the amount of time elapsed since the previous focused user activity, the distance from the identified information item of most recent focus, etc. In other words, the occupancy percentage of an information item is directly proportional to the ability of the item to draw attention. Various other modeling techniques can be used by those skilled in the art to take such additional complexity into account. When the total number of presented items competing for attention in the same presentation channel(s) exceeds a threshold, the items with relatively less ability to draw attentions may not receive any attention units, simulating information overloading. In this regard it should be noted that research has shown that typical humans can only pay attention to no more than five to seven items concurrently, so when more than seven information items are presented concurrently, the items with occupancy percentages less than the 7^{th} lowest item will not receive any attention.

The measurement of user's attention strength toward an information item is based upon the detection of user-active events (or user's proactive interaction with the information item) such that the information item gains the undivided attention of the user. For example, when the user's proactive interaction tasks associated with a computer system, such as keyboard input, mouse actions to highlight, cut and paste, or other proactive interactions from devices such as digital pens, game controllers, etc. are performed on a presented information item, the information item can be said to have the undivided attention of the user.

The detection of user-active events should take into consideration the lag time in between detectable events. However, during any periods when a threshold in lag time indicating a lack of attention is exceeded, the user's attention strength would be measured with reference to presentation channel characteristics and the manner in which the information item is situated within that channel, instead of with reference to actual user interaction. The lag time threshold can be established in various ways. For example, in the case of the typing, the lag time threshold could either be a fixed amount of delay between keystrokes based on average users, or calibrated through apparatus or software applications to be more user-specific.

The attention that a user gives to an information item can also be measured through other kinds of attention tracking devices, ranging, without limitation, from other human observes to equipment such as eye motion tracking devices, etc.

When measuring attention based on user interactions with presented information item(s), it is also necessary to detect deliberate user absence. This condition can be measured via attention monitoring devices or through the detection of the absence of any user activities over a preset time threshold, as well as through the detection of system events such as screen saver activation within a computer.

Aforementioned monitoring and measuring activation toward information item provide a way to quantify the importance, usefulness and relevance of the information item; namely, the higher the activation of an information item is, the more important, useful and relevant the information item would be to the user, since the activation is measured based on how the information item has been drawn the user's attention through past interactions. Based on activation toward information items, the present invention provides ways to manage, organize and retrieve information items.

Bookmark is a commonly used technique for easing access to the web pages for the future use without memorizing lengthy IP address or URL for later use of the information, and managing the information through a friendly named label. However, one of the problem with existing bookmark technique is that once the bookmark is created for a particular information item, regardless of the change in importance, usefulness or relevance, the bookmark will not be removed or be re-prioritized automatically. The management of bookmarks through friendly names also has its fallacies, as users will quickly run out of ideas for creative names and would have to manage the set of bookmarks through categorization, which in turn grows fast with the amount of interested information, and leaves the user the task for managing bookmarks. The present invention provides automatic means to manage information items based importance, usefulness or relevance by taking advantage of activation of information items.

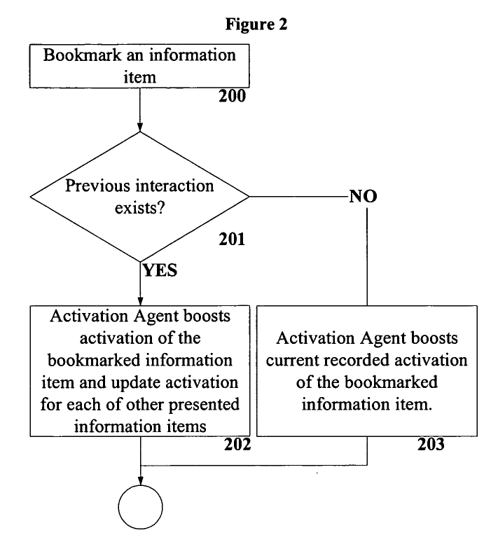

FIG. 2 illustrates a flow chart of bookmarking process in the preferred embodiment of the present invention. When bookmarking an information item 200 is requested, it will confirm whether there is any previous interaction at step 201. If the previous interaction exists, then, activation agent boosts activation of the bookmarked information item and update activation for each of other associated information items, accordingly at step 202. If there was no previous interaction, the current recorded activation will be boosted at step 203.

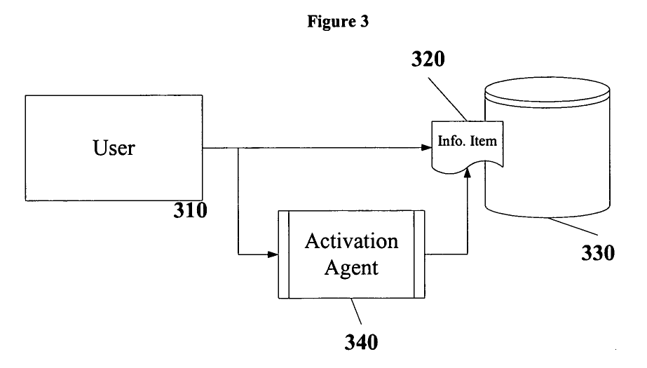

In the preferred embodiment of this invention, bookmark of an information item by a user will cause activation of the information item to be elevated, more preferably, by increasing a base activation of the information item in a certain degree so that importance, usefulness and relevance of the information item or activation of the information item will be increased. FIG. 3 illustrates a system view of how bookmarking takes place. The user 310 may boost the activation of information item 320, more specifically, the base activation toward the information item 320 by (a) single or multiple injections of attention units (i.e. artificially inserting a single or multiple interactions) through the activation agent 340 to the bookmarked information item, (b) applying a gain for boosting activation units of subsequent interaction with the bookmarked information item 320, so that activation would increases faster than the other information items that are not bookmarked, (c) adjusting decay parameter, d, of the equation [II] for the information item 320 such that it slows down the pace of “forgetting,” or (d) combination of two or all of (a), (b) and (c). The gain parameter, mentioned in option (b), may be managed separately by the activation agent 340 or may be stored and managed with the information item 320 as a property. Similarly, the decay parameter, d, in option (c) may be managed separately by the activation agent 340 or may be stored and managed with the information item 320. Optionally, the options and parameters associated with the options can be set through a user interface presenting them to the user, such as presenting choice of one-time only boosting, boosting at every consumption of the information item being bookmarked, single interaction boosting, multiple interaction boosting etc. This is to be noted that, in the preferred embodiment of the present invention, bookmarking of an information item is treated in the same way as an interaction of the information items except for base activation of the information item.

Optionally, the preferred embodiment of the present invention may provide a user a choice of adjusting the activation of information items negatively (or depressing the activation of information items) by bookmarking the information items that the user may want to “forget” quickly or intentionally. This may be achieved by (a) eliminating single or multiple recent activation units (i.e. taking out a single or multiple interactions), (b) applying a negative gain for attenuating activation units of subsequent interaction with the negatively bookmarked information items, (c) adjusting decay parameter, d, of the equation [II] for the information item such that it speed up the pace of “forgetting,” or (d) combination of two or all of (a), (b) and (c).

One advantage over conventional method of bookmarking information items is that, with the present invention, even the activation of the information item had once been elevated by bookmarking process in the past, the activation of the information item will decay over time if the information item is not being accessed for a period of time, thus its importance, usefulness or relevance of the information item (or activation of the information item) is automatically reduced accordingly; where, with the existing system, regardless of changes in actual importance over the time, the importance/priority of the information item will not be changed till the user manually change its rating. And, even worse, the burden on the user for managing such priorities of information items will grow much heavier as the number of user's information items increases.

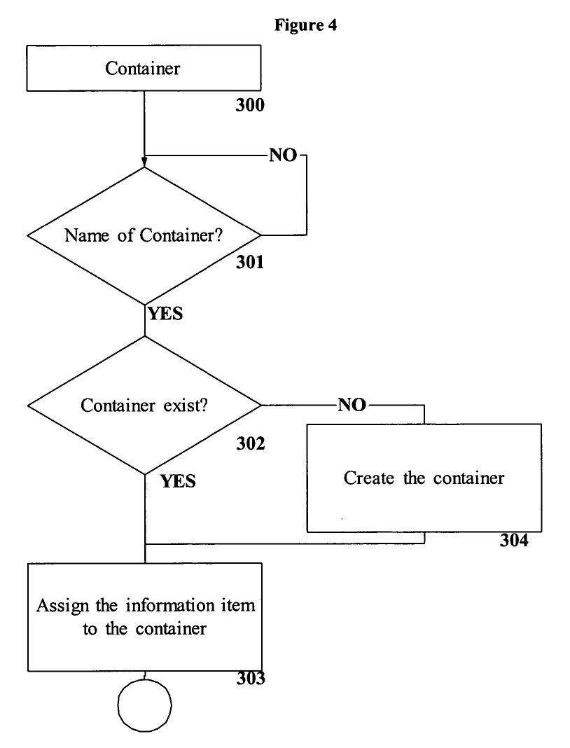

In the preferred embodiment of the present invention, a virtual folder, or contextual container may be defined by the user for grouping or categorizing a plurality of information items, or member information items, based on context, subject, time, etc. FIG. 4 illustrates a flow chart for generating container in the preferred embodiment of the present invention. Once generation of container is requested at step 300, it confirms whether the name of the container is presented by the user or not at step 301. If it is confirmed, then it confirms whether the container exists already or not at step 302. If it does, then the bookmarked information item would be assigned to the container that is already existed at step 303; otherwise, it will create the container at step 304, then assign the bookmarked information item to the newly created container at step 303.

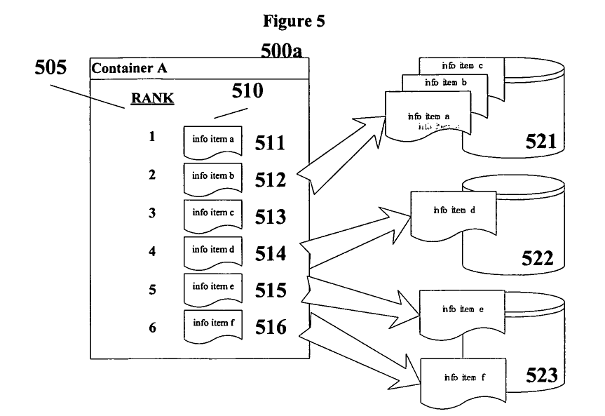

Since the container is virtual or logical, the actual or physical storage locations of information items under a container may be scattered around in different folders, directories, databases, hard drive disks, servers or any structured data storage means or devices. FIG. 5 illustrates an example of Container A 500a containing a number of information items. Container A 500a contains bookmarks of information items, namely information item a 511, information item b 512, information item c 513, information item d 514, information item e 515, and information item f 515 in the bookmark list 510, referencing back to the physical location of the information items, namely a first storage means 521 storing information item a 511, information item b 512, and information item c 513, a second storeage means 522 storing information item d 514, and a third storage means 523 storing information item e 515 and information item f 516. The information item list 510 is sorted based on activation and ranked as list 505. For implementation, containers may be managed separately from the information items (i.e. having a separate structured storage means for managing information regarding containers and member information items), or may be managed with information items (i.e. container information may be managed as a property of the information item/attribute).

Since a container is for grouping a plurality of information items, in the preferred embodiment of the present invention, the container itself is also considered to be an information item, and, thus it contains its own activation. A folder (or directory) is also treated as an information item. Accessing a container causes both base activation of the container and associated activation of its member information items to be gained accordingly.

Accessing a member information item in a container, in turn, may cause both base activation of the member information item and the associative activation of other member information items and the container to be adjusted. However, from a practical point of view, associative activation of other member information items may not be adjusted for the association/relevance may not be sufficient enough.

The user may bookmark a container or folder by boosting the base activation of the container or folder, respectively. Note that, since information items that are members of the container or folder (or “member information items”) are, in fact, related to the container or folder, bookmarking the container or folder by boosting activation may cause the associative activation of the member information items to be adjusted accordingly as if the container or folder is accessed.

Optionally, the number of information items or bookmarks that one container can hold may be limited to avoid cluttering the container with less important or less useful bookmarks. Once the number of member information items (or bookmarks) in one container exceeds the limit, the member information items with the lowest activation may be removed or “forgotten” automatically or manually (by prompting the user) from the container so that total number of bookmarks in one container is always below or equal to this limit.

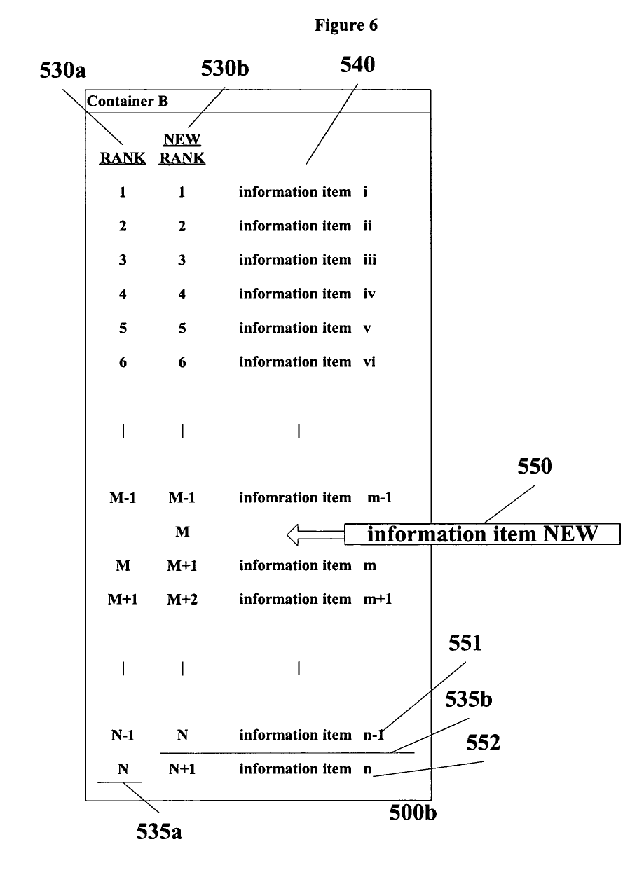

FIG. 6 illustrates an example of how the container limits the number of bookmarked information items to be in. List of bookmarked information items 540 are listed in Container B, 500b in an ascending order according to activation with ranking shown in the list 530a. Maximum number of information items allowed in a container is assumed to be N in this example, showing 535a as the line for the limit. Once a new information item 550 is bookmarked, it is assumed that the information item is now ranked at M, right after M−1, thus all the information items after M will be shifted its ranking down by one, i.e. ranked at M in the original rank 530a is now ranked at M+1 in the new rank 530b. As it is shown, information item n 552 once ranked at N is now shifted down to N+1, and it is below the limit line, 535b. Therefore, the information item n 552 will be removed from Container B 500b, and the information item n−1, 551 will be at the bottom, Nth rank, in Container B 500b. The number of bookmarks in one container may be predetermined or defined by the user for each or all containers.

Likewise, the number of containers that the user can define in a personal computerized system may also be limited under a certain number. Once the number of containers exceeds the limit, the container with the lowest activation may be removed or “forgotten” automatically or manually by prompting the user from the container so that total number of containers in the system is always below or equal to this limit. In currently available bookmark methods, users often find themselves creating similar categories of bookmarks many times. Within present invention, the not so important containers are automatically shifted in ranks and forgotten, thus requires no management effort from the user.

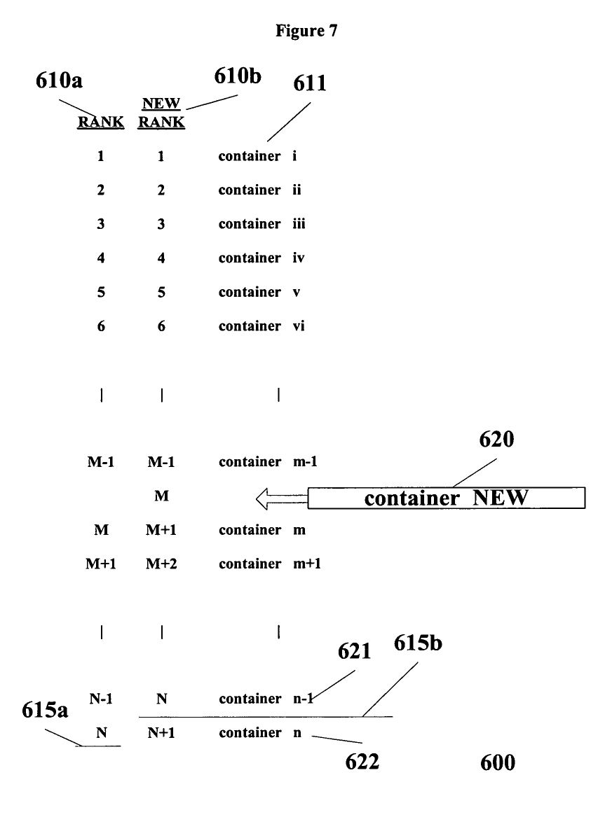

FIG. 7 illustrates an example of how the system limits the number of containers. The list 600 of containers 611 are prioritized in an ascending order based on the activation ranking as shown in 610a, assuming the number of containers that has been defined by a user is N. It is also assumed that the maximum number of containers that one can define in a system is N. The line 615a is placed after rank N in the original rank 610a, or after the container n 622, which indicates the limit at the bottom of the list 600. When the new container 620 is defined by the user, assume that it ranked right after M−1 of the original rank 610a, and taking rank at M−th, thus all other containers ranked after M in the original rank 610a would be shifted down by one rank. The container n 622 would now be ranked at N+1 as shown in the new rank 610b, the container n−1 would now be ranked at N, and the limit line 615b would be placed between the container n−1 621 and the container n 622; then, the container n 622 would be removed from the list 600, since the container n 622 is least important, least useful and least relevant based on the activation. The number of containers that the user can define may be predetermined or can be defined by the user.

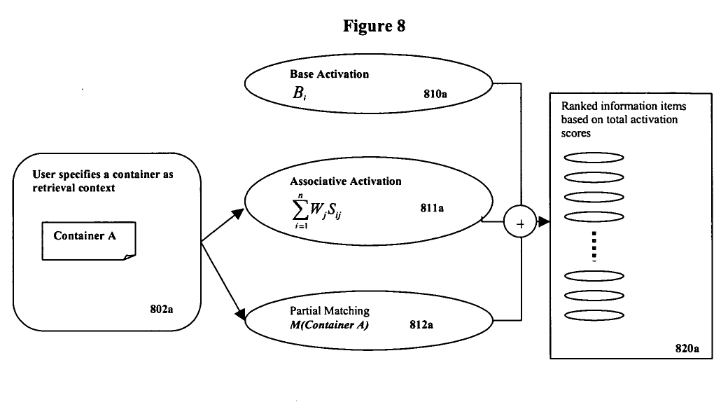

FIG. 8 illustrates an example of how the system ranks information items based on the activation scores. We may view a container as a retrieval context as shown in 802a. Once it is specified, activation of each information items grouped in the container are measured with base activation 810a, associative activation 811a, and partial matching, wherein the context/goal is specified as Container A as shown in 812a. Then, the system will rank the information items inside the container as shown in 820a.

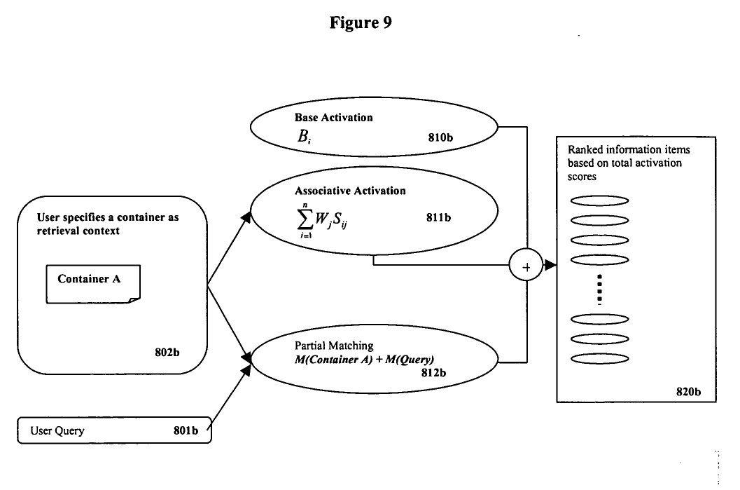

FIG. 9 illustrates an example of how the system ranks information items associated with a container based on search query. The user specifies a container as retrieval context 802b, and user query has been entered 801b. Then, the context is examined to evaluate associative activation 811b, and the partial matching 812b with user query. These results with base activation 810b are combined to examine and rank information items resides in the container 820b.

Thus a software module, method and system for managing information items through activation of the information items are disclosed. When applying present invention to the enterprise, personal data can be pooled to provide individual metrics, synergy of knowledge and statistics reflecting working patterns and productivity of individuals and working groups.

It is to be understood that the embodiments and variations shown and described herein are merely illustrations of the principles of this invention and that various modifications may be implemented by those skilled in the art without departing from the spirit and scope of the invention.

What is claimed is:

1. An information management software module for managing information items by bookmarking through activation of said information items executing on a personal computerized system, said software module comprises instructions:
to receive a first input from a user for specifying any of said information items for bookmarking;
to adjust said activation of said any of said information items aforementioned; and
to store said adjusted activation of said any of said information items aforementioned in a storage means;
wherein said activation of said information items is continuously updated simultaneously as said user consume said information items by said software module, and said software module comprise instructions:
to monitor and measure attention strengths of said user on each of said information items presented on a presentation channel;
to measure activation of said information items over time; and
to store said activation of said information item in said storage means;
wherein said software module ranks searched information items, and said software module further comprises instructions:
to receive a second input from said user for search criteria; and
to retrieve and to rank one or more information items, which match said search criteria, according to said activation of said information items.

2. The information management software module as recited in claim 1, wherein said activation of said information items is measured and estimated through mathematical modeling of activation toward said information items, wherein said mathematical modeling comprising instructions:
(i) to model a base activation of said information item over time, wherein said modeling is modeling cumulative nature of base activation and a decay in human memory;
(ii) to model an associative activation of said information item;
(iii) to model a partial matching of said information item toward a goal; and
(iv) to model a noise factor.

3. The information management software module as recited in claim 1, wherein said attention strength is directed by said user towards one of one or more information items present in a presentation channel during an interaction period in which said user directs attention towards a target information item through one or more proactive or passive interactions with said target information item.

4. The information management software module as recited in claim 3, wherein said measuring of said attention strength of said user comprising instructions:
(i) to record the start time of said interaction period as represented by the start of an event through which said user directs attention towards said target information item;
(ii) to record the end time of said interaction period as represented by either (a) the passage of a specified period of time during which said user does not direct any attention towards said target information item, or
(b) the start of another event that confirms that said user is not directing any attention towards said target information item;
(iii) to measure the duration of said interaction period as difference between said end time and said start time of said interaction period;
(iv) to divide said duration of said interaction period into attention units appropriate to corresponding said presentation channel;
(v) to count the number of attention units within said interaction period during which said user directed attention towards said information item proactively;
(vi) to count the number of attention units within said interaction period during which said user directed attention towards the information item passively;
(vii) to allocate said attention units recited in sub-step 0 to said target information item; and
(viii) to allocate said attention units recited in sub-step 0 among said target information item and all of the rest of said information items present in said presentation channel, based on the presentation characteristics of each of said information items in said presentation channel.

5. The information management software module as recited in claim 4, wherein said confirmation of said user who is not directing any attention towards said target information item is confirmed by any of:
detecting said another event has gained undivided attention of said user;
detecting said another event caused occupancy percentage of said target information item become less than the lowest occupancy percentage of the information item that the typical humans can pay attention to; and
detecting the absence of any user activity over a predefined time threshold.

6. The information management software module as recited in claim 4, wherein said presentation channel is either visual or auditory.

7. The information management software module as recited in claim 6, wherein said attention unit of said visual presentation channel is predetermined in the range of 200 to 400 milliseconds.

8. The information management software module as recited in claim 3, wherein said attention strength of said user is measured by an attention tracking device.

9. The information management software module as recited in claim 8, wherein said attention tracking device is eye tracking device.

10. The information management software module as recited in claim 4, wherein said attention unit of said auditory presentation channel is predetermined as the smallest note length perceptible by humans.

11. The information management software module as recited in claim 10, wherein said attention unit is approximately 1/128 second or one or more multiple of said smallest note length.

12. The information management software module as recited in claim 1, wherein said bookmarking comprises at least one of the following instructions:
to insert a single or multiple user interactions with said information item artificially for adjusting activation of said information item;
to modify modeling of said decay in human memory for slowing decay of said activation of said information item over time; and
to apply a gain in subsequent activation of said information item for increasing said activation of said information item faster than said information items that are not bookmarked.

13. The information management software module as recited in claim 12, wherein said instructions for said bookmarking said information items and parameters associated with said instructions are selectable by said user.

14. The information management software module as recited in claim 1 further comprises an instruction to define a plurality of containers for grouping said bookmarked information items by receiving an input from said user for the name of each of said plurality of containers.

15. The information management software module as recited in claim 14, wherein said software module further comprises an instruction to limit a number of said bookmarked information items to be assigned to each of said plurality of containers by removing any of said bookmarked information items having lower activation than the lowest ranking allowed in said container.

16. The information management software module as recited in claim 15, wherein said number is defined by said user.

17. The information management software module as recited in claim 15, wherein said number is predefined.

18. The information management software module as recited in claim 14, wherein said software module further comprises an instruction to limit a number of said containers that said user can define in said computer system by removing any of said containers having lower in the activation than the lowest in ranking allowed.

19. The information management software module as recited in claim 18, wherein said number limiting said containers in said system is defined by said user.

20. The information management software module as recited in claim 18, wherein said number limiting said containers in said system is predetermined.

21. The information management software module as recited in claim 14, wherein said container is an information item.

22. The information management software module as recited in claim 1, wherein said information items comprise folders and user data files associated with user applications, wherein said user application comprises e-mail, Web browser, multimedia related and office related application softwares.

23. The information management software module as recited in claim 12, wherein said bookmarking comprises at least one of the following instructions:
to omit a single or multiple user interactions with said information item for adjusting activation of said information item;
to modify modeling of said decay in human memory for speeding up decay of said activation of said information item over time; and
to apply an attenuation in subsequent activation of said information item for increasing said activation of said information item slower than said information items that are not bookmarked.

24. A method for managing information items by bookmarking information items on a personal computerized system through activation toward said information items, said method of managing information items comprises steps of:
receiving a first input from a user for specifying any of said information items for bookmarking;
adjusting said activation of said any of said information items aforementioned; and
storing said adjusted activation of said any of said information items aforementioned being adjusted in a storage means;
wherein said method comprises a plurality of steps for updating said activation of said information items continuously and simultaneously as said user consume said information items, and said plurality of steps for updating said activation of said information items comprise steps of:
monitoring and measuring attention strengths of said user on each of said information items presented on a presentation channel;
measuring activation of said information items over time; and
storing said activation of said information item in said storage means;
wherein said method further comprises a plurality of steps for ranking searched information items, and said plurality of steps for ranking searched information items comprises steps of:
receiving a second input from said user for search criteria; and
retrieving and ranking one or more information items, which match said search criteria, according to said activation of said information items.

25. The method for managing said information items as recited in claim 24, wherein said activation of said information items is measured and estimated through mathematical modeling of activation toward said information items, wherein said mathematical modeling comprising sub-steps of:
(i) modeling a base activation of said information item over time, wherein said modeling is modeling cumulative nature of base activation and a decay in human memory;
(ii) modeling an associative activation of said information item;
(iii) modeling a partial matching of said information item toward a goal; and
(iv) modeling a noise factor.

26. The method for managing said information items as recited in claim 24, wherein said attention strength is directed by said user towards one of one or more information items present in a presentation channel during an interaction period in which said user directs attention towards a target information item through one or more proactive or passive interactions with said target information item.

27. The method for managing said information items as recited in claim 26, wherein said measuring of said attention strength of said user comprising sub-steps of:
(i) recording the start time of said interaction period as represented by the start of an event through which said user directs attention towards said target information item;
(ii) recording the end time of said interaction period as represented by either (a) the passage of a specified period of time during which said user does not direct any attention towards said target information item, or
(b) the start of another event that confirms that said user is not directing any attention towards said target information item;
(iii) measuring the duration of said interaction period as difference between said end time and said start time of said interaction period;
(iv) dividing said duration of said interaction period into attention units appropriate to corresponding said presentation channel;
(v) counting the number of attention units within said interaction period during which said user directed attention towards said information item proactively;
(vi) counting the number of attention units within said interaction period during which said user directed attention towards the information item passively;
(vii) allocating said attention units recited in sub-step 0 to said target information item; and
(viii) allocating said attention units recited in sub-step 0 among said target information item and all of the rest of said information items present in said presentation channel, based on the presentation characteristics of each of said information items in said presentation channel.

28. The method for managing said information items as recited in claim 27, wherein said confirmation of said user who is not directing any attention towards said target information item is confirmed by any of:
(i) detecting said another event has gained undivided attention of said user;
(ii) detecting said another event caused occupancy percentage of said target information item become less than the lowest occupancy percentage of the information item that the typical humans can pay attention to; and
(iii) detecting the absence of any user activity over a predefined time threshold.

29. The method for managing said information items as recited in claim 27, wherein said presentation channel is either visual or auditory.

30. The method for managing said information items as recited in claim 29, wherein said attention unit of said visual presentation channel is predetermined in the range of 200 to 400 milliseconds.

31. The method for managing said information items as recited in claim 26, wherein said attention strength of said user is measured by an attention tracking device.

32. The method for managing said information items as recited in claim 31, wherein said attention tracking device is eye tracking device.

33. The method for managing said information items as recited in claim 27, wherein said attention unit of said auditory presentation channel is predetermined as the smallest note length perceptible by humans.

34. The method for managing said information items as recited in claim 33, wherein said attention unit is approximately 1/128 second or one or more multiple of said smallest note length.

35. The method for managing said information items as recited in claim 24, wherein said bookmarking comprises at least one of the following steps:
inserting a single or multiple user interactions with said information item artificially for adjusting activation of said information item;
modifying modeling of said decay in human memory for slowing decay of said activation of said information item over time; and
applying a gain in subsequent activation of said information item for increasing said activation of said information item faster than said information items that are not bookmarked.

36. The method for managing said information items as recited in claim 35, wherein said instructions for said bookmarking said information items and parameters associated with said instructions are selectable by said user.

37. The method for managing said information items as recited in claim 24 further comprises a step to define a plurality of containers for grouping said bookmarked information items by receiving an input from said user for the name of each of said plurality of containers.

38. The method for managing said information items as recited in claim 37, wherein said method further comprises a step of limiting a number of said bookmarked information items to be assigned to each of said plurality of containers by removing any of said bookmarked information items having lower activation than the lowest ranking allowed in said container.

39. The method for managing said information items as recited in claim 38, wherein said number is defined by said user.

40. The method for managing said information items as recited in claim 38, wherein said number is predefined.

41. The method for managing said information items as recited in claim 37, wherein said method for managing said information items further comprises a step of limiting a number of said containers that said user can define in said computer system by removing ones of said containers having lower in said activation than the lowest in ranking allowed.

42. The method for managing said information items as recited in claim 41, wherein said number limiting said containers in said system is defined by said user.

43. The method for managing said information items as recited in claim 41, wherein said number limiting said containers in said system is predetermined.

44. The method for managing said information items as recited in claim 37, wherein said container is of an information item.

45. The method for managing said information items as recited in claim 24, wherein said information items comprise folders and user data files associated with user applications, wherein said user application comprises e-mail, Web browser, multimedia related and office related application softwares.

46. The method for managing said information items as recited in claim 35, wherein said bookmarking comprises at least one of the following steps of:
(i) omitting a single or multiple user interactions with said information item for adjusting activation of said information item;
(ii) modifying modeling of said decay in human memory for speeding up decay of said activation of said information item over time; and
(iii) applying an attenuation in subsequent activation of said information item for increasing said activation of said information item slower than said information items that are not bookmarked.

47. A system for managing information items by bookmarking said information items through activation of said information items on a personal computerized system comprises:
(i) a first input means for receiving input from a user for bookmarking said information item; and
(ii) a processing means for adjusting said activation of said information items that said user bookmarked;
wherein said system further comprises means for updating said activation of said information items continuously and simultaneously as said user consumes and for retrieving and ranking said information items, comprising:
(iii) a second input means for sensing user attention strengths of said information items;
(iv) said processing means for measuring attention strengths of said information items, and for measuring activation of information items over time;
(v) a storage means for storing activation information of said information items; and
(vi) said processing means for searching and retrieving from said information items based on search criteria, and for ranking retrieved information items based on said activation of said information items.

48. The system for managing said information items as recited in claim 47, wherein said activation of said information items is measured and estimated by said processing means based on a mathematical modeling of activation toward said information items by:
(i) modeling a base activation of said information item over time, wherein said modeling is modeling cumulative nature of base activation and a decay in human memory;
(ii) modeling an associative activation of said information item;
(iii) modeling a partial matching of said information item toward a goal; and
(iv) modeling a noise factor.

49. The system for managing said information items as recited in claim 47, wherein said attention strength is directed by said user towards one of one or more information items present in a presentation channel during an interaction period in which said user directs attention towards a target information item through one or more proactive or passive interactions with said target information item.

50. The system for managing said information items as recited in claim 49, wherein said attention strength of said user is measured by said processing means through:
(i) recording the start time of said interaction period as represented by the start of an event through which said user directs attention towards said target information item;
(ii) recording the end time of said interaction period as represented by either
(a) the passage of a specified period of time during which said user does not direct any attention towards said target information item, or
(b) the start of another event that confirms that said user is not directing any attention towards said target information item;
(iii) measuring the duration of said interaction period as difference between said end time and said start time of said interaction period;
(iv) dividing said duration of said interaction period into attention units appropriate to corresponding said presentation channel;
(v) counting the number of attention units within said interaction period during which said user directed attention towards said information item proactively;
(vi) counting the number of attention units within said interaction period during which said user directed attention towards the information item passively;
(vii) allocating said attention units recited in sub-step 0 to said target information item; and
(viii) allocating said attention units recited in sub-step 0 among said target information item and all of the rest of said information items present in said presentation channel, based on the presentation characteristics of each of said information items in said presentation channel.

51. The system for managing said information items as recited in claim 50, wherein said confirmation of said user who is not directing any attention towards said target information item is confirmed by either:
(i) said processing means detecting said another event has gained undivided attention of said user;
(ii) said processing means detecting said another event caused occupancy percentage of said target information item become less than the lowest occupancy percentage of the information item that the typical humans can pay attention to; or
(iii) said processing means detecting the absence of any user activity over a predefined time threshold.

52. The system for managing said information items as recited in claim 50, wherein said presentation channel is either visual or auditory.

53. The system for managing said information items as recited in claim 52, wherein said attention unit of said visual presentation channel is predetermined in the range of 200 to 400 milliseconds.

54. The system for managing said information items as recited in claim 47, wherein said second input means is an attention tracking device.

55. The system for managing said information items as recited in claim 54, wherein said attention tracking device is eye tracking device.

56. The system for managing said information items as recited in claim 50, wherein said attention unit of said auditory presentation channel is predetermined as the smallest note length perceptible by humans.

57. The system for managing said information items as recited in claim 56, wherein said attention unit is approximately 1/128 second or one or more multiple of said smallest note length.

58. The system for managing said information items as recited in claim 47, wherein said processing means boosts said activation of said information items by at least one of the followings:
(i) inserting a single or multiple user interactions with said information item artificially for adjusting activation of said information item;
(ii) modifying modeling of said decay in human memory for slowing decay of said activation of said information item over time; and
(iii) applying a gain in subsequent activation of said information item for increasing said activation of said information item faster than said information items that are not bookmarked.

59. The system for managing said information items as recited in claim 58, wherein said instructions for said bookmarking said information items and parameters associated with said instructions are selectable by said user.

60. The system for managing said information items as recited in claim 47 comprises said processing means for defining a plurality of containers for grouping said bookmarked information items by receiving an input from said user for the name of each of said plurality of containers.

61. The system for managing said information items as recited in claim 60, wherein said processing means limits a number of said bookmarked information items to be assigned to each of said plurality of containers by removing any of said bookmarked information items having lower activation than the lowest ranking allowed in said container.

62. The system for managing said information items as recited in claim 61, wherein said number is defined by said user.

63. The system for managing said information items as recited in claim 40, wherein said number is predefined.

64. The system for managing said information items as recited in claim 60, wherein said processing means limits a number of said containers that said user can define in said computer system by removing ones of said containers having lower in said activation than the lowest in ranking allowed.

65. The system for managing said information items as recited in claim 64, wherein said number limiting said containers in said system is defined by said user.

66. The system for managing said information items as recited in claim 64, wherein said number limiting said containers in said system is predetermined.

67. The system for managing said information items as recited in claim 60, wherein said container is of an information item.

68. The system for managing said information items as recited in claim 47, wherein said information items comprise folders and user data files associated with user applications, wherein said user application comprises e-mail, Web browser, multimedia related and office related application softwares.

69. The method for managing said information items as recited in claim 58, wherein said processing means depresses said activation of said information item through bookmarking by at least one of followings:
(i) omitting a single or multiple user interactions with said information item for adjusting activation of said information item;
(ii) modifying modeling of said decay in human memory for speeding up decay of said activation of said information item over time; and
(iii) applying an attenuation in subsequent activation of said information item for increasing said activation of said information item slower than said information items that are not bookmarked.
